(19) United States
(12) Patent Application Publication
(10) Pub. No.: US 2011/0261693 A1
(43) Pub. Date: Oct. 27, 2011

(54) METHOD AND APPARATUS FOR OPTIMIZING DATA TRAFFIC IN SYSTEM COMPRISING PLURAL MASTERS

(75) Inventor: Kwang Won KO, Seoul (KR)

(73) Assignee: Samsung Electronics Co., Ltd., Suwon-si (KR)

(21) Appl. No.: 13/092,454

(22) Filed: Apr. 22, 2011

(30) Foreign Application Priority Data
Apr. 22, 2010 (KR) 10-2010-0037258

(51) Int. Cl. H04L 12/26

(52) U.S. Cl. 370/230.1

(57) ABSTRACT

A data traffic optimization method and apparatus is provided for guaranteeing data transmission service quality such that the plural masters transmit data within a time period according to the data amount optimized for the corresponding master. The method includes acquiring a control factor for controlling the data traffic, issuing a traffic control signal according to a determination whether to open or block data transfer of a master to a bus, and controlling the master to continue or stop transferring data according to the traffic control signal issued by the traffic optimizer.

### PRIORITY

This application claims priority under 35 U.S.C. §119 to an application entitled “Method and Apparatus for Optimizing Data Traffic In System Comprising Plural Masters” filed in the Korean Intellectual Property Office on Apr. 22, 2010 and assigned Serial No. 2010-0037258, the contents of which are incorporated herein by reference.

### BACKGROUND OF THE INVENTION

1. Field of the Invention

The present invention relates generally to a method and apparatus for optimizing data traffic in a system having a plurality of masters, and more particularly, to a data traffic optimization method and apparatus for guaranteeing data transmission service quality such that each of the plural masters transmits data within a time period according to the data amount optimized for the corresponding master.

2. Description of the Related Art

System on Chip (SoC) refers to the integration of all components of a computer or other electronic system into a single integrated circuit and, typically, is applied in the area of embedded systems.

With the increasing complexity of SoC, a plurality of masters is integrated within an SoC. In order for the plural masters to transmit data simultaneously in the conventional SoC, the priorities of the individual masters are adjusted for usage right of the bus interconnecting the components in the system. As such, in the conventional method, the multiple masters generating data transmission requests are ordered simply by priority without guaranteeing data traffic appropriate within a specific time period.

Such a conventional method has a drawback in that the Quality of Service (QoS) of the data traffic is not guaranteed since each master is assigned priority statically or dynamically.

Accordingly, there is a need of a data traffic optimization method for accurately guaranteeing QoS of the data traffic in the system including a plurality of masters.

### SUMMARY OF THE INVENTION

In order to solve the problems of the prior art, the present invention provides a data traffic optimization method and apparatus for guaranteeing service quality of data traffic by allowing each of masters to transmit an amount of data within a time period according to the optimized data transfer amount of each master.

In accordance with an aspect of the present invention, a method for optimizing data traffic in a system having plural masters includes acquiring, at a traffic optimizer, a control factor for controlling the data traffic, issuing, at the traffic optimizer, a traffic control signal according to a determination whether to open or block data transfer of a master to a bus, and controlling the master, at a traffic controller connected to the master, to continue or stop transferring data according to the traffic control signal issued by the traffic optimizer.

In accordance with another aspect of the present invention, an apparatus for optimizing data traffic in a system having plural masters includes a traffic optimizer which acquires a control factor for controlling the data traffic, determines whether to open or block data transfer of a master to a bus, and issues a traffic control signal according to a determination result, and a traffic controller which is connected to the master and controls the master to continue or stop transferring data according to the traffic control signal issued by the traffic optimizer.

### BRIEF DESCRIPTION OF THE DRAWINGS

The above and other objects, features and advantages of the present invention will be more apparent from the following detailed description in conjunction with the accompanying drawings, in which:

FIG. 1 illustrates a configuration of a data traffic optimization apparatus according to the present invention;

FIG. 2 illustrates a configuration and operations of the traffic controller of FIG. 1 according to the present invention;

FIG. 3 illustrates a configuration of the traffic optimizer of FIG. 1 according to the present invention;

FIG. 4 illustrates a configuration of the traffic optimizer of FIG. 1 according to the present invention;

FIG. 5 illustrates operations of function blocks of the data traffic optimization apparatus according to the present invention;

FIG. 6 illustrates operations of the traffic optimizer of FIG. 1 according to the present invention;

FIG. 7 illustrates operations of the traffic controller according to the present invention; and

FIG. 8 illustrates graphs showing improvement of the data traffic optimization method according to the present invention.

### DETAILED DESCRIPTION OF EMBODIMENTS OF THE PRESENT INVENTION

Embodiments of the present invention are described with reference to the accompanying drawings in detail. The same reference numbers are used throughout the drawings to refer to the same or like parts. Detailed description of well-known functions and structures incorporated herein may be omitted for the sake of clarity and conciseness.

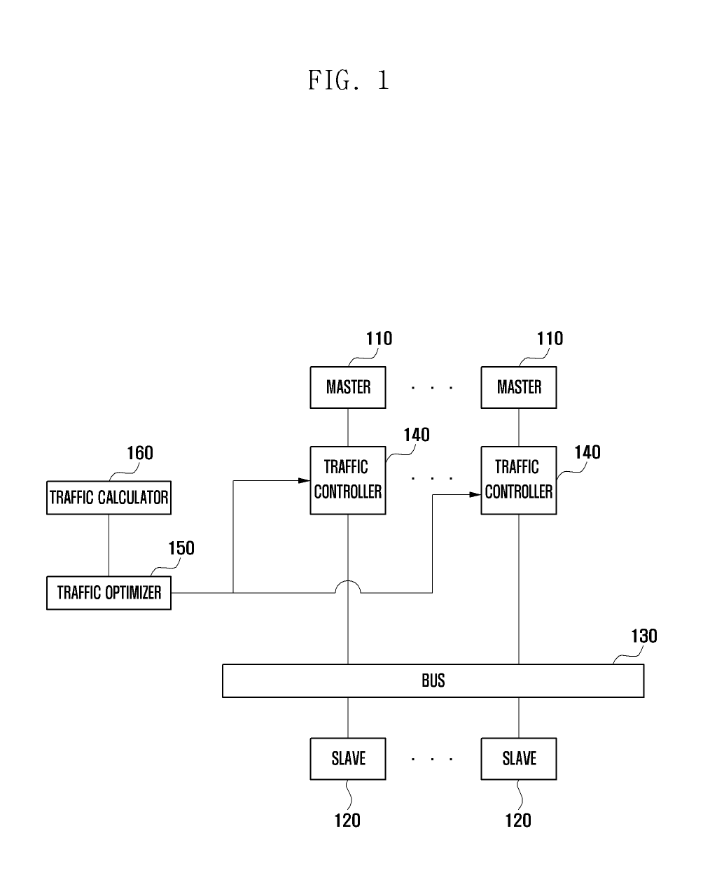

FIG. 1 illustrates a data traffic optimization apparatus according to the present invention. As shown in FIG. 1, the data traffic optimization apparatus includes at least one master 110, at least one slave 120, a bus 130, at least one traffic controller 140, a traffic optimizer 150, and a traffic calculator 160.

The master 110 is a component as a subject of the operation for executing a task in the system (e.g., SoC) including at least one master. The data traffic optimization apparatus can include a plurality of masters 110, and the masters are denoted by the same reference number 110 for simplicity purposes, although they operate individually.

The slave 120 operates according to a command of the master 110. The data traffic optimization apparatus can include a plurality of slaves, which are denoted by the same reference number 120 for simplicity purposes although they operate individually. The slave 120 can be a component such as a memory.

The bus 130 is a path over which the control signals and data are transferred among the components of the data traffic optimization apparatus.

The traffic controller 140 is responsible for coupling the master 110 to the bus 130 and controls data traffic transferred to the slave 120. In more detail, the traffic controller 140 opens or blocks the data transfer from the master 110 to the slave 120 according to the traffic control signal output by the traffic optimizer 150.

The traffic controller 140 reports the transferred data amount to the traffic optimizer 150 after transferring the data. The traffic optimizer 150, as described hereinbelow, determines whether to control the traffic controller 140 to continue transferring data based on the reported data amount. If the data amount transferred in a time period is greater than a data amount, the traffic controller 140 blocks data transfer under the control of the traffic optimizer 150.

The traffic optimizer 150 optimizes the data traffic of the individual masters 110 in the data traffic optimization apparatus. For this purpose, the traffic optimizer 150 receives a parameter (to be described later) to be used for optimizing data traffic from an application, and acquires the control factor necessary for optimizing the data traffic with the parameter.

According to the present invention, the control factor indicates the transfer limit amount of individual masters 110. The traffic optimizer 150 controls the traffic controllers 140 according to the acquired control information, to open or block the data transfer from the master 110 to the slave 120.

The traffic optimizer 150 also receives the report on the data amount transferred by the master 110 connected to the traffic controller 140 through the bus 110 from the traffic controller 140, determines whether to allow the corresponding master 110 to continue transferring data, based on the reported data amount, and issues a data transfer open signal or a data transfer block signal to the traffic controller 140 according to the determination result.

The traffic calculator 160 receives the parameter necessary for calculating the control factor from the traffic optimizer 150, calculates the control factor for optimizing the data traffic using the received parameter, and transfers the control factor to the traffic optimizer 150. Optimizing data traffic refers to maximizing the total data transfer amount of a plurality of masters over a bus.

According to the present invention, the traffic calculator 160 is a basic Linear Programming Solver. The traffic calculator 160 configures the data transfer amount of each master as a variable (x) using the parameter received from the traffic optimizer 150 and solves the linear programming problem by multiplying a weight factor (p) with the variable as expressed by Expression (1):

$$max {\sum }_{i = 0}^{N} {p}_{i} {x}_{i} \\ subject to \\ \begin{matrix}i ) {x}_{i} \geq \frac{{d}_{i}}{{t}_{frame}} & ( Critical deadline for each channel ) \\ ii ) {x}_{i + 1} \geq \frac{{d}_{i}}{{d}_{i + 1}} {x}_{i} & ( Related data amount ) \\ iii ) {\sum }_{i = 0}^{N} {x}_{i} \leq {X}_{max} & ( The maximum capacity of bus ) \\ iv ) {\sum }_{i = 0}^{N} {x}_{i} \leq μ - \frac{1}{w} & ( Prevent from the pannalty of waiting transfer )\end{matrix} \qquad ( 1 )$$

where, pᵢ denotes the weight of each bus master determined by application, xᵢ denotes a variable (maximum assigned transfer rate result value of each bus master), dᵢ denotes data amount to be transferred per unit time, t_{frame} denotes unit time, Xₘₐₓ denotes maximum transfer rate allowed in system, μ denotes average processing time of bus slave, w denotes maximum transaction delay tolerable to bus slave, and N denotes number of bus masters.

The method for solving the linear programming problem can be a Graphical Solution, Algebraic Solution, and Numerical Solution that are well known to those skilled in the art, and thus a detailed description thereon is omitted herein for the sake of conciseness. The control factor is calculated by the aforementioned method and restricts the data transfer amount of each master.

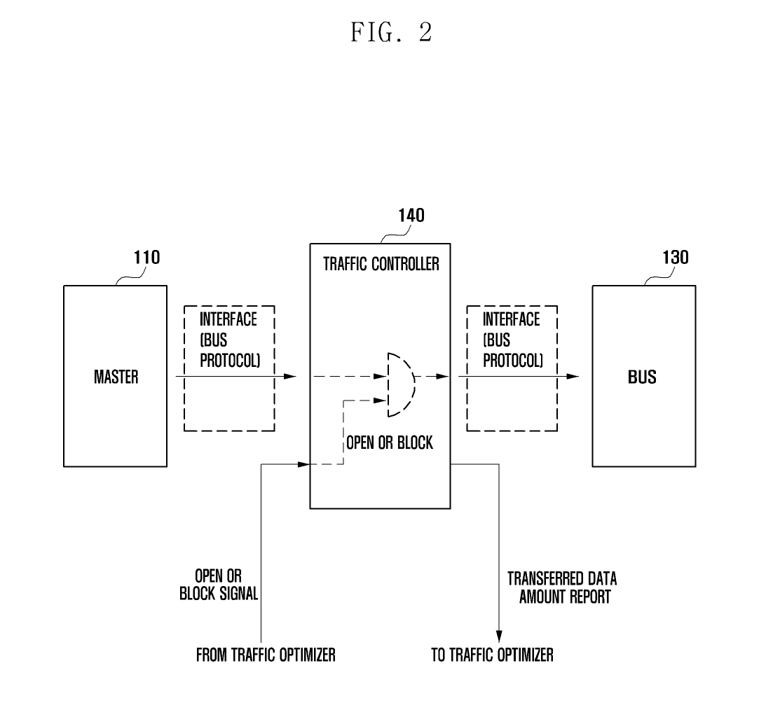

FIG. 2 illustrates a configuration and operations of the traffic controller of FIG. 1 according to the present invention.

As shown in FIG. 2, the traffic controller 140 transfers the data output by the master 110 over the bus 130. In this case, the data output by the master 110 or the traffic controller 140 is transferred to the traffic controller 140 and the bus 130.

The traffic controller 140 receives the data transfer open signal or data transfer block signal from the traffic optimizer 150. When the data transfer open signal is received, the traffic controller 140 continues transferring data from the master 110 to the bus 130. Otherwise, when the data transfer block signal is received, the traffic controller 140 blocks the data transfer from the master 110 to the bus 130.

For this purpose, the traffic controller 140 is provided with an AND gate to control the data flow from the master 110 to the bus 130. That is, if the signal received from the traffic optimizer 150 is 1, the traffic controller 140 interprets the signal as the data transfer open signal to continue the data transfer. If the signal is 0, the traffic controller 140 interprets the signal as the data transfer block signal to block the data transfer. However, it is noted that it is not mandatory for the traffic controller 140 to be provided with the AND gate.

After transferring data to the bus, the traffic controller 140 reports the amount of the data transferred in a time period to the traffic optimizer 150. If it is determined that the data amount transferred in the time period is greater than a set amount, the traffic controller 140 blocks data transfer under the control of the traffic optimizer 150. This process optimizes the data transfer amount per unit time in view of the entire SoC system including the application.

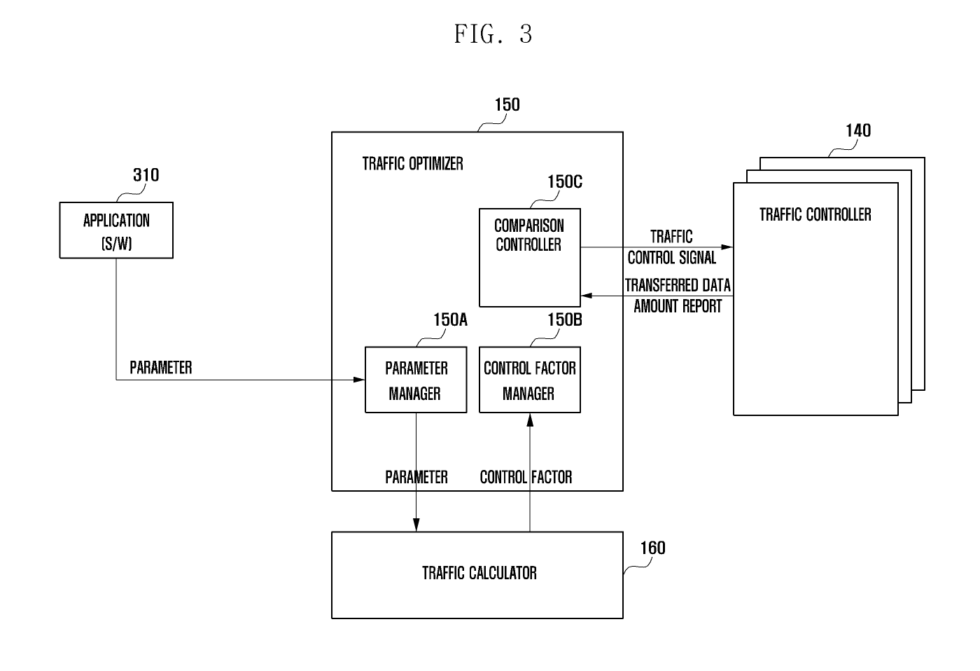

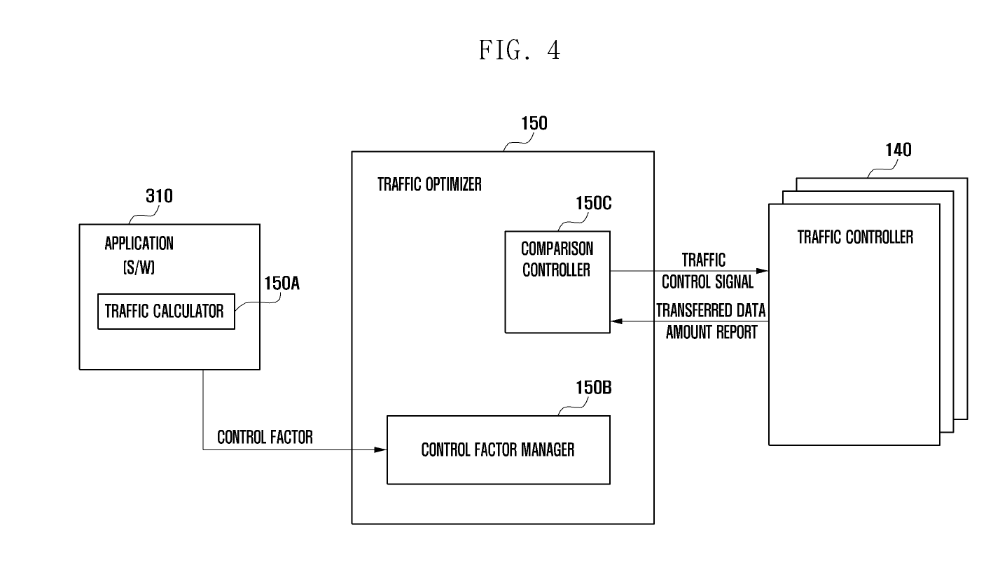

FIG. 3 illustrates a configuration of the traffic optimizer of FIG. 1 according to the present invention. As shown in FIG. 3, the traffic optimizer 150 includes a parameter manager 150A, a control factor manager 150B, and a comparison controller 150C. In FIG. 3, the traffic calculator 160 is designed in the form of hardware. The traffic calculator 160 designed in software is to be described with reference to FIG. 4.

The traffic optimizer 150 optimizes the data traffic of each master 110 in the data traffic optimization apparatus according to the present invention.

For this purpose, the parameter manager 150A receives parameters for optimizing data traffic from an application (also referred to as software or SW). The parameters can include at least one of weight of each master, maximum assigned transfer rate result value, data amount to be transmitted by unit time, maximum transfer rate in the system, average processing time of slave, maximum tolerable transaction delay of slave, and the number of masters.

The traffic calculator 160 calculates the control factor for optimizing the data traffic using the parameters received from the parameter manager 150A. The method for calculating the control factor using the received parameters has been described already with reference to FIG. 1; thus, a detailed description thereof is omitted for the sake of conciseness. The traffic calculator 160 sends the calculated control factor to the control factor manager 150B.

The control factor manager 150B receives the control factor from the traffic calculator 160 and manages the received control factor. The control factor manager 150B can save the received control factor or update the control factor received periodically according to the execution unit of the application.

The comparison controller 150C issues the traffic control signal for the traffic controller 140 to determine whether to continue data transfer. For this purpose, the comparison controller 150C receives the data transfer amount reported by the traffic controller 140. The comparison controller 150C also compares the control factor and the data transfer amount and, if the value indicator by the control factor is greater than the data transfer amount, issues the data transfer open signal to the traffic controller 150 such that the master 110 to continue data transfer.

Otherwise, if the data amount is greater than the value indicated by the control factor, the comparison controller 150C issues the data transfer block signal to the traffic controller 150 such that the master 110 stops data transfer. The traffic controller 140 controls the master 110 to continue or stop data transmission according to the data transfer open signal and data transfer block signal issued by the comparison controller 150C.

FIG. 4 illustrates a configuration of the traffic optimizer 150 of FIG. 1 according to the present invention. Although it is designed in hardware in the embodiment of FIG. 3, the traffic calculator 160 can be designed in software as described with reference to FIG. 4.

The embodiment of FIG. 4 differs from that of FIG. 3 in that the traffic calculator 150A is logically incorporated in the application 410. According to the embodiment of FIG. 4, the traffic calculator 150A receives the parameters for optimizing the data traffic directly from the application. The traffic calculator 150A calculates the control factor necessary for optimizing the data traffic using the received parameters and outputs the control factor to the control factor manager 150B.

In short, the traffic calculator 150A is designed in the traffic optimizer 150 when it is implemented in hardware so as to receive the parameters from the application and outputs the control factor calculated with the parameter. In view of the traffic optimizer 150, the traffic optimizer 150 receives the parameters from the software and calculates the control factor for optimizing the data traffic.

When the traffic calculator 150A is implemented in software, it is designed to be integrated in the application so as to output the control factor calculated with the parameter received from the application. The traffic optimizer 150 receives the control factor for optimizing the data traffic from the software.

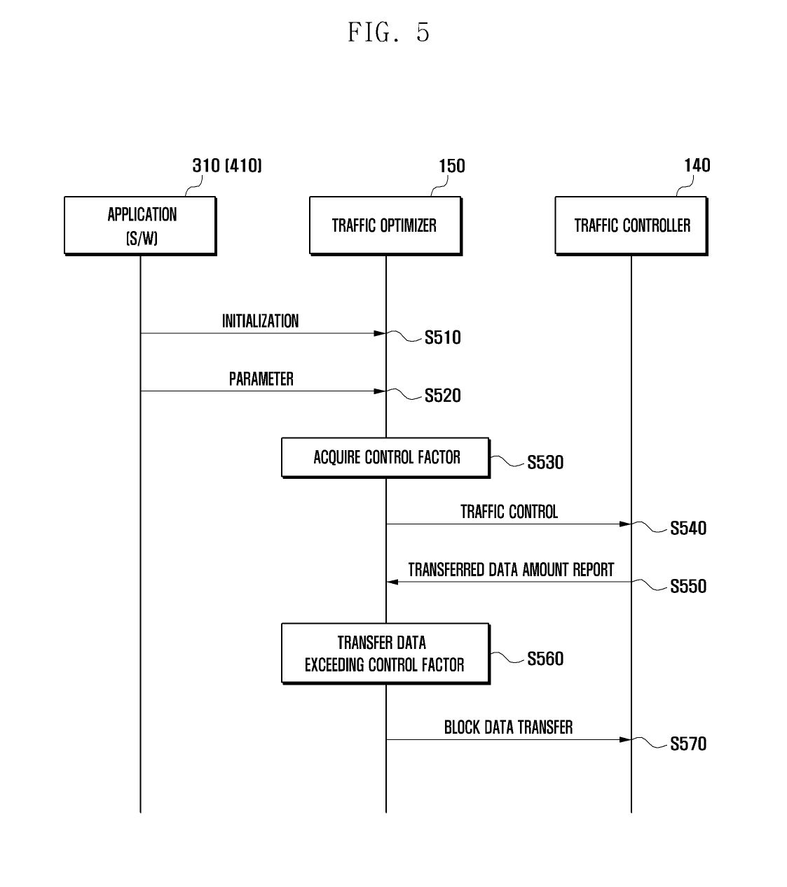

FIG. 5 illustrates operations of function blocks of the data traffic optimization apparatus according to the present invention.

Prior to executing traffic optimization, the application 310 (410) initializes the parameters of the traffic optimizer 150 in step S510. Next, the application 310 sends the parameters necessary for optimizing data traffic to the traffic optimizer 150 in step S520. As described above, the parameters transferred to the traffic optimizer 150 can include at least one of the weight of each master, the maximum assigned transfer rate result value of each master, the data amount to be transmitted per unit time, the maximum data rate available in the system, the average processing time of salve, the maximum tolerable transaction delay of slave, and the number of masters. The traffic optimizer 150 acquires the control factor for optimizing data traffic using the parameters received in step 530.

Alternatively, the traffic optimizer 150 can directly acquire the control factor calculated by the application. In this case, the traffic optimizer 150 can skip step S530 for calculating the control factor.

After acquiring the control factor, the traffic optimizer 150 controls the traffic controller 140 to adjust data traffic in step 540. Particularly, the traffic optimizer 150 issues the data transfer open signal to the traffic controller 140 such that the master 110 can transfer data to the slave 120.

The traffic optimizer 150 receives the data transfer amount reported periodically by the traffic controller 140 in step S550. The traffic optimizer 150 determines whether to allow the master 110 to transfer data based on the data transfer amount reported by the traffic controller 140. For this purpose, the traffic optimizer 150 compares the control factor with the reported data transfer amount in step S560. If the reported data transfer amount is greater than the control factor, the traffic optimizer 150 issues the data transfer block signal to the traffic controller 140 so as to block the data transfer of the master 110 in step S570. Otherwise, the data transfer of the master 110 is permitted.

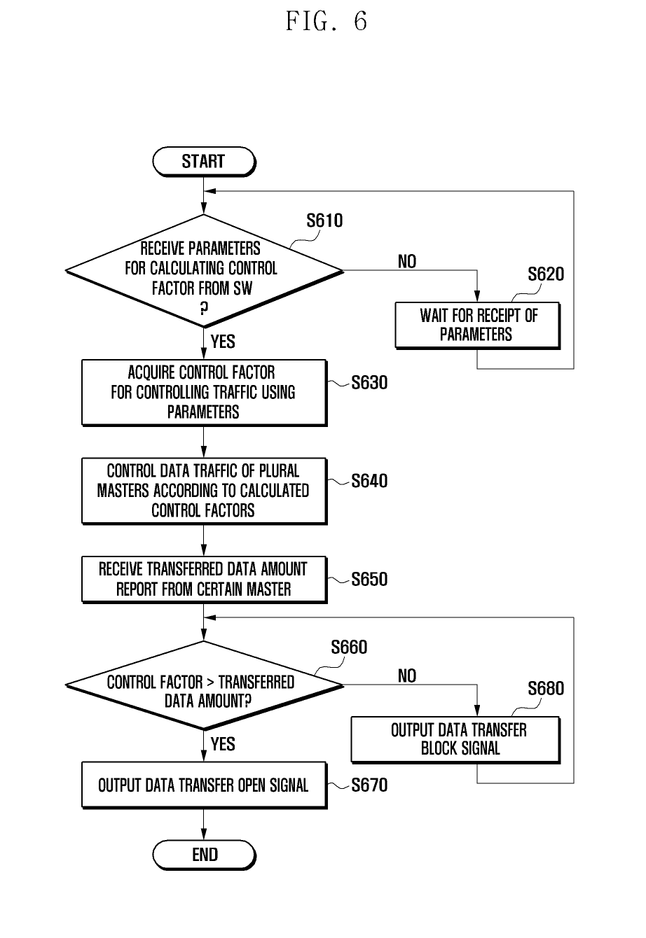

FIG. 6 illustrates operations of the traffic optimizer 150 according to the present invention.

The traffic optimizer 150 monitors to detect the receipt of the parameter necessary for calculating the control information from the application (or software) in step S610. If there is no parameter received, the traffic optimizer 150 waits until the parameter is received in step S620. If there is a parameter received at step S610, the traffic optimizer 150 acquires the control factor for controlling traffic using the received parameter in step S630. Alternatively, the traffic optimizer 150 can directly acquire the control factor calculated by the application 410.

The traffic optimizer 150 controls data traffic of one or more masters 110 using the acquired control factor in step S640. For this purpose, the traffic optimizer 150 first issues the data transfer open signal to allow the masters to transfer data. Next, the traffic optimizer 150 receives the data amount transferred in a time period reported by the traffic controller 140 in step S650.

Upon receipt of the transferred data amount report, the traffic optimizer 150 compares the control factor with the reported data amount in step S660. If the control factor is greater that the reported data amount, the traffic optimizer 150 issues the data transfer open signal to the traffic controller 140 in step S670. The data transfer open signal instructs the traffic controller 140 to continue transferring data.

Otherwise, if the reported data amount is equal to or greater than the control factor, the traffic optimizer 150 issues the data transfer block signal to the traffic controller 140 in step S680. The data transfer block signal instructs the traffic controller 140 to block data transfer.

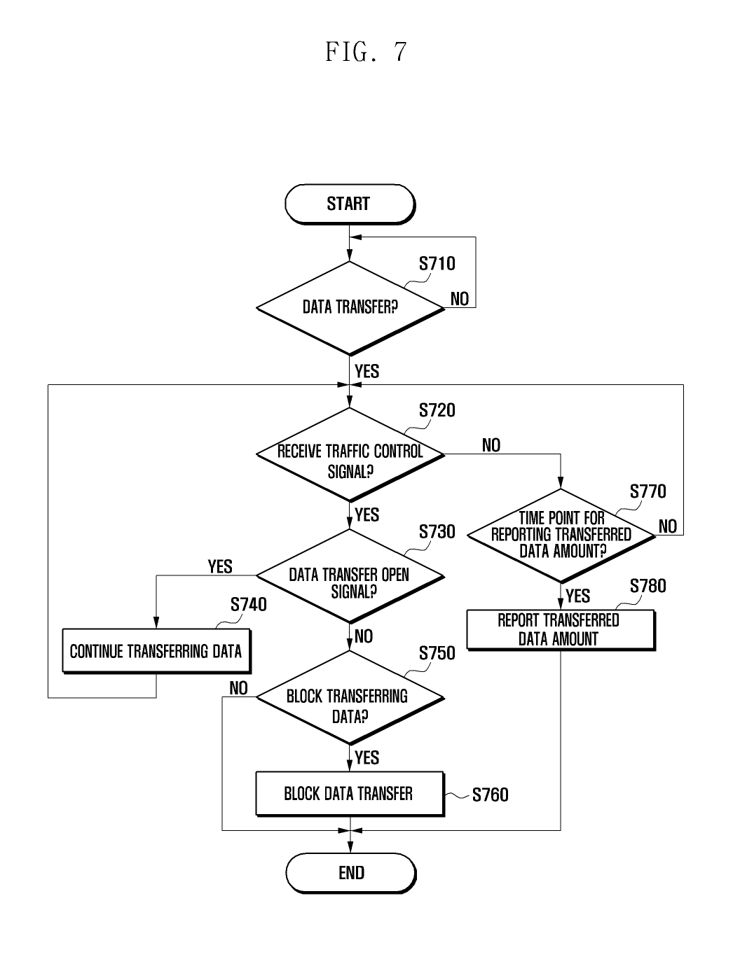

FIG. 7 illustrates operations of the traffic controller according to the present invention.

First, the traffic controller 140 determines whether the master is transferring data in step S710. If it is determined that the master is transferring data, the traffic controller 140 determines whether a traffic control signal is received from the traffic optimizer 150 in step S720. If the traffic control signal is received, the traffic controller 140 determines whether the traffic control signal is the data transfer open signal in step S730. If the traffic control signal is the data transfer open signal, the traffic controller 140 continues transferring data in step S740. That is, the traffic controller 140 controls the master 110 to transfer data over the bus 130.

Otherwise, if the traffic control signal is not the data transfer open signal at step 730, the traffic controller 140 determines whether the traffic control signal is the data transfer block signal in step S750. If the traffic control signal is the data transfer block signal, the traffic controller 140 blocks the data transfer in step S760. That is, the traffic controller 140 controls the master 110 to stop transferring data over the bus 130.

If the traffic control signal is not received at step S720, the traffic controller 140 determines whether the data transfer amount report time has arrived in step S770. If the data transfer amount report time has arrived, the traffic controller 140 reports the data amount transferred for a time period to the traffic optimizer 150 in step S780.

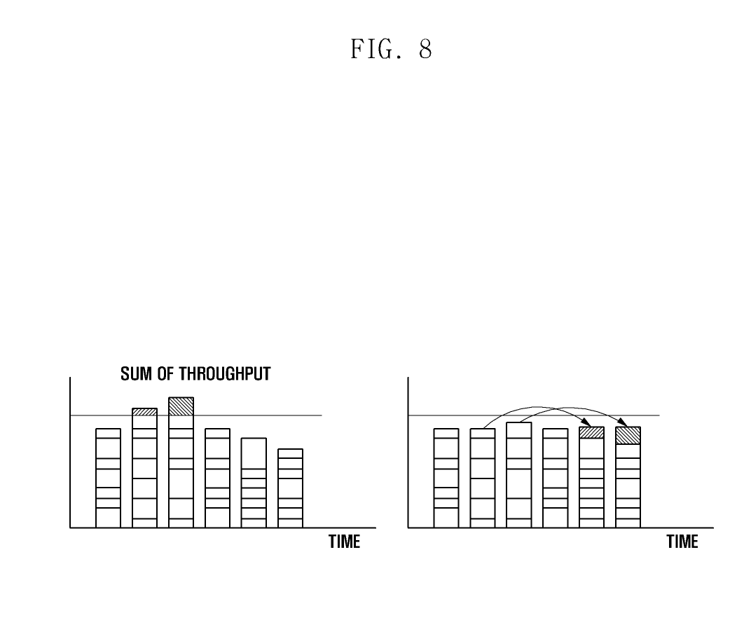

FIG. 8 illustrates graphs showing improvement of the data traffic optimization method according to the present invention.

As shown in FIG. 8, the conventional method causes a problem in that the masters do not use the shared bus efficiently because the data transfer amounts of individual masters are irregular over time. That is, the data transfer amount varies unexpectedly so as to be greater than the entire system throughput at a first time and less than the system throughput at a second time different from the first time. Accordingly, such a conventional method cannot guarantee the QoS of the data transfer of each master and thus causes degradation of system utilization.

The present invention solves the aforementioned problems by distributing the data traffic in time domain and dynamically controlling the data transfer amount of each master. As a consequence, the present invention guarantees the QoS of data transfer of each master and improves system utilization efficiency.

As described above, the data traffic optimization method and apparatus of the present invention adjusts bandwidth assignment amount of each of plural masters in consideration of the status of the application and data traffic status on the bus, and therefore regulates the data transfer amount by controlling the individual masters to transfer data according to the optimized data transfer amount, resulting in guaranteeing QoS of data traffic.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for optimizing data traffic in a system having plural masters, comprising:
acquiring, at a traffic optimizer, a control factor for controlling the data traffic;
issuing, at the traffic optimizer, a traffic control signal according to a determination of whether to open or block data transfer of a master to a bus; and
controlling, at a traffic controller connected to the master, the master to continue or stop transferring data according to the traffic control signal issued by the traffic optimizer.

2. The method of claim 1, wherein acquiring the control factor comprises:
obtaining, at a traffic calculator, parameters for calculating the control factor from a running application;
calculating, at the traffic calculator, the control factor maximizing data transfer amount of the masters on bus resource determined with the parameter; and
transferring the control factor to the traffic optimizer.

3. The method of claim 2, wherein the parameters comprise at least one of weight of each master, maximum assigned transfer rate value, data amount to be transferred per unit time, maximum transfer rate available in system, average processing time of a slave, tolerable transaction delay of a slave, and a number of masters.

4. The method of claim 1, further comprising receiving, after acquiring the control factor, a report on transferred data amount from a certain master to the bus for a period, the transferred data amount report being sent by the traffic controller.

5. The method of claim 1, wherein issuing the traffic control signal comprises:
comparing the control factor with a transferred data amount;
outputting, when the control factor is equal to or greater than the transferred data amount, a data transfer block signal; and
outputting, when the control factor is less than the transferred data amount, a data transfer open signal.

6. The method of claim 1, further comprising initializing, before acquiring a control factor, the traffic optimizer by a running application.

7. An apparatus for optimizing data traffic in a system having plural masters, comprising:
a traffic optimizer for acquiring a control factor for controlling the data traffic, determining whether to open or block data transfer of a master to a bus, and issuing a traffic control signal according to a determination result; and
a traffic controller, connected to the master, for controlling the master to continue or stop transferring data according to the traffic control signal issued by the traffic optimizer.

8. The apparatus of claim 7, further comprising a traffic calculator for obtaining parameters for calculating the control factor from a running application, calculating, at the traffic calculator, the control factor maximizing data transfer amount of the masters on bus resource determined with the parameter, and transferring the control factor to the traffic optimizer.

9. The apparatus of claim 8, wherein the parameters comprise at least one of weight of each master, maximum assigned transfer rate value, data amount to be transferred per unit time, maximum transfer rate available in system, average processing time of a slave, tolerable transaction delay of a slave, and a number of masters.

10. The apparatus of claim 7, wherein the traffic controller periodically reports an amount of data transferred from the master to the bus for a period.

11. The apparatus of claim 10, wherein the traffic optimizer compares the control factor with the transferred data amount, outputs, when the control factor is equal to or greater than the transferred data amount, a data transfer block signal and outputs, when the control factor is less than the transferred data amount, a data transfer open signal.

12. The apparatus of claim 7, wherein the traffic optimizer initializes, before acquiring a control factor, the traffic optimizer by a running application.
